(19) United States
(12) Patent Application Publication
(10) Pub. No.: US 2007/0280623 A1
(43) Pub. Date: Dec. 6, 2007

(54) LIGHT INTEGRATION ROD

(75) Inventor: Tung-Hsing Tsou, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/691,143

(22) Filed: Mar. 26, 2007

(30) Foreign Application Priority Data
May 29, 2006 (TW) 95118963

(51) Int. Cl. G02B 6/10

(52) U.S. Cl. 385/146

(57) ABSTRACT

A light integration rod including a first flat Plate, a second flat plate opposite to the first flat plate, a first folded plate and a second folded plate opposite to the first folded plate is provided. The first and the second folded plates are respectively connected between the first and the second flat plates to form a hollow pillar. Each of the first and the second folded plates has a first part and a second part. The first part of the first folded plate is connected to an edge of the first flat plate, and the second part of the first folded plate is connected to an edge of the second flat plate. The first part of the second folded plate is connected to an edge of the second flat plate, and the second part of the second folded plate is connected to an edge of the first flat plate.

### CROSS-REFERENCE TO RELATED APPLICATION

This application claims the priority benefit of Taiwan application serial no. 95118963, filed May 29, 2006. All disclosure of the Taiwan application is incorporated herein by reference.

### BACKGROUND OF THE INVENTION

1. Field of the Invention

The present invention relates to an optical element for an optical projection apparatus, and more particularly, to a light integration rod.

2. Description of Related Art

An optical projection apparatus, such as an optical projector, generally includes an illumination system, an imaging system and a projection lens. The illumination system provides an illuminating light beam, the imaging system converts the illuminating light beam into an image light beam, and the projection lens projects the image light beam on a screen, for example. A light integration rod is normally disposed in the illumination system to homogenize the light beam from the illumination system.

FIG. 1 is a schematic cross-sectional view of a conventional light integration rod. FIG. 2 is a schematic cross-sectional view showing a flat plate structure of a conventional light integration rod. As shown in FIG. 1, a conventional light integration rod 100 comprises four flat plates 110a, 110b, 120a and 120b. The flat plate 110a is opposite to the flat plate 110b, and a shape of the flat plate 110a is identical to a shape of the flat plate 110b. Similarly, the flat plate 120a is opposite to the flat plate 120b, and a shape of the flat plate 120a is identical to a shape of the flat plate 120b. The flat plates 120a and 120b are attached between the flat plates 110a and 110b through a glue to form a hollow pillar. Each of the flat plates 110a, 110b, 120a and 120b comprises a glass substrate 132, an adhered reinforcement layer 134, a reflective layer 136 and a transparent protective layer 138. The adhered reinforcement layer 134 is disposed on the glass substrate 132, and the reflective layer 136 is disposed on the adhered reinforcement layer 134. The transparent protective layer 138 is disposed on the reflective layer 136.

When the light beam is transmitted inside the light integration rod 100, some of the energy of the light beam is absorbed by the light integration rod 100 to generate heat, and the high temperature of the light integration rod 100 causes it thermally expanding. Since different materials of the respective flat plates 110a, 110b, 120a and 120b have different coefficients of thermal expansion, the degree of expansion in various layers of the respective flat plates 110a, 110b, 120a and 120b is different. As a result, the glass substrate 132 may easily crack due to pressure. Furthermore, the glue used for holding the flat plates may degrade when being subject to heat which in turn may lead to deformation of the light integration rod 100. Ultimately, the uniformity of the light beam output from the light integration rod 100 is adversely influenced. Moreover, the adhered reinforcement layer 134, generally fabricated by using the material such as nickel or silicon, has a poor bonding with the glass substrate 132. Therefore, the adhered reinforcement layer 134 may easily peel off, and the attached reflective layer 136 may peel off along with the adhered reinforcement layer 134. Consequently, the conventional light integration rod 100 has a low reliability.

### SUMMARY OF THE INVENTION

Accordingly, one objective of the present invention is to provide a light integration rod for homogenizing a light beam provided by a light source in an optical projection apparatus.

Another objective of the present invention is to provide a light integration rod capable of resolving a low-reliability problem encountered in the conventional art.

Other objectives, features and advantages of the present invention will be further understood from the further technology features disclosed by the embodiments of the present invention wherein there are shown and described embodiments of this invention, simply by way of illustration of modes best suited to carry out the invention.

To achieve one or some or all of these and other advantages of the invention, as embodied and broadly described herein, the invention provides a light integration rod suitable for homogenizing a light beam from a light source in an optical projection apparatus. The light integration rod includes a first flat plate, a second flat plate, a first folded plate and a second folded plate. The first flat plate is opposite to the second flat plate, and a shape of the first flat is identical to a shape of the second flat plate. The first folded plate is opposite to the second folded plate, and a shape of the first folded plate is identical to a shape of the second folded plate. The first folded plate and the second folded plate are respectively connected between the first flat plate and the second flat plate to form a hollow pillar. Each of the first and the second folded plates has a first part and a second part. The first part of the first folded plate is connected to one edge of the first flat plate, and the second part of the first folded plate is connected to one edge of the second flat plate. The first part of the second folded plate is connected to another edge of the second flat plate, and the second part of the second folded plate is connected to another edge of the first flat plate. The directions of extension of the first parts of the first and the second folded plates are identical, and the directions of extension of the second parts of the first and the second folded plates are identical.

In one embodiment of the present invention, bends of the foregoing first folded plate and the second folded plate protrude away from a region between the first flat plate and the second flat plate. In addition, both the widths of the first flat plate and the second flat plate are D1 and a shortest distance between the first flat plate and the second flat plate is D2. Furthermore, a ratio D1/D2 or D2/D1 is, for example, equal to an aspect ratio of an imaging system of the optical projection apparatus. Moreover, a distance between the bend of the first folded plate and an imaginary line joining ends of the first flat plate and the second flat plate closest to the first folded plate and a distance between the bend of the second folded plate and the imaginary line joining the ends of the first flat plate and the second flat plate closest to the second folded plate are, for example, between 0.1 mm˜0.4 mm.

In one embodiment of the present invention, the bends of the foregoing first folded plate and the second folded plate cave into the region between the first flat plate and the second flat plate. In addition, the shortest distance between the first flat plate and the second flat plate is D2, and a distance between the top of the bend of the first folded plate and the top of the bend of the second folded plate is D3. Furthermore, a ratio D3/D2 or D2/D3 is, for example, equal to the aspect ratio of the imaging system of the optical projection apparatus.

In one embodiment of the present invention, a junction between the first folded plate and the first flat plate, a junction between the first folded plate and the second flat plate, a junction between the second folded plate and the first flat plate, and a junction between the second folded plate and the second flat plate have, for example, rounded corners or truncated corners.

In one embodiment of the present invention, each of the first flat plate, the second flat plate, the first folded plate and the second folded plate includes a metallic substrate, a reflective layer disposed on the metallic substrate, and a transparent protective layer disposed on the reflective layer.

In one embodiment of the present invention, the foregoing light integration rod further includes a fixing component surrounding the first flat plate, the second flat plate, the first folded plate and the second folded plate to fix the first flat plate, the second flat plate, the first folded plate and the second folded plate.

The present invention also provides an alternative light integration rod suitable for homogenizing a light beam from a light source in an optical projection apparatus. The light integration rod includes a first flat plate, a second flat plate, a third flat plate, and a fourth flat plate. The first flat plate is opposite to the second flat plate. The third flat plate and the fourth flat plate are respectively connected between the first flat plate and the second flat plate to form a hollow pillar. Each of the first flat plate, the second flat plate, the third flat plate and the fourth flat plate includes a metallic substrate, a reflective layer disposed on the metallic substrate and a transparent protective layer disposed on the reflective layer.

In one embodiment of the present invention, a junction between the third flat plate and the first flat plate, a junction between the third flat plate and the second flat plate, a junction between the fourth flat plate and the first flat plate, and a junction between the fourth flat plate and the second flat plate have, for example, rounded corners or truncated corners.

In one embodiment of the present invention, the foregoing light integration rod includes a fixing component surrounding the first flat plate, the second flat plate, the third flat plate and the fourth flat plate to fix the first flat plate, the second flat plate, the third flat plate and the fourth flat plate.

In one embodiment of the present invention, a material constituting the metallic substrate of the two embodiments of the foregoing light integration rods is selected from a group of nickel and silicon.

In one embodiment of the present invention, a material constituting the reflective layer of the two embodiments of the foregoing light integration rods includes silver.

In one embodiment of the present invention, a material constituting the transparent protective layer of the embodiments of the two foregoing integration rods includes argon.

A cross-section of an optical path of the light integration rod in the present invention is approximate to a hexagonal shape so that the light beam emerging from the light integration rod is homogenized. Moreover, by using the metallic substrate in various flat plates and folded plates constituting the light integration rod, the defect of the film being easily peeled off from the glass substrate in the conventional technique can be avoided. Hence, the reliability of the light integration rod is enhanced.

It is to be understood that both the foregoing general description and the following detailed description are exemplary, and are intended to provide further explanation of the invention as claimed.

### BRIEF DESCRIPTION OF THE DRAWINGS

In the following detailed description of the embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Accordingly, the drawings and descriptions will be regarded as illustrative in nature and not as restrictive.

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional light integration rod.

FIG. 2 is a schematic cross-sectional view showing a flat plate structure of a conventional light integration rod.

FIG. 3A is a perspective view of a light integration rod according to a first embodiment of the present invention.

FIG. 3B is a schematic cross-sectional view of the light integration rod in FIG. 3A.

FIG. 4 is a diagram showing a pattern for brightness and uniformity testing recommended by American National Standards Institute (ANSI).

FIG. 5 is a schematic cross-sectional view of a first flat plate, a second flat plate, a first folded plate, and a second folded plate in the light integration rod according to the first embodiment of the present invention.

FIGS. 6A and 6B are schematic cross-sectional views showing another two types of the light integration rods according to the first embodiment of the present invention.

FIGS. 7A to 7C are schematic cross-sectional views showing another three types of the light integration rods according to the first embodiment of the present invention.

FIG. 8 is a perspective view of a light integration rod according to a second embodiment of the present invention.

FIG. 9 is a schematic cross-sectional view showing a first flat plate, a second flat plate, a third flat plate and a fourth flat plate of the light integration rod according to the second embodiment of the present invention.

FIG. 10 is a perspective view of another type of the light integration rod according to the second embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

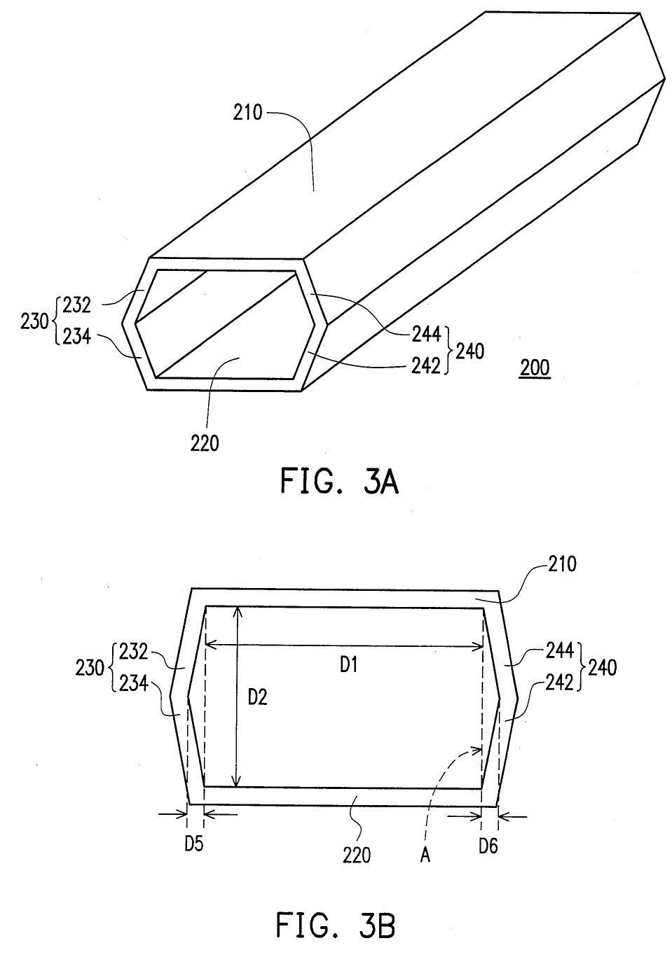

As shown in FIGS. 3A and 3B, a light integration rod 200 in the present embodiment is suitable for homogenizing a light beam from a light source in an optical projection apparatus (not shown). The light integration rod 200 includes a first flat plate 210, a second flat plate 220, a first folded plate 230 and a second folded plate 240. The first flat plate 210 is opposite to the second flat plate 220, and a shape of the first flat plate 210 is identical to a shape of the second flat plate 220. Similarly, the first folded plate 230 is opposite to the second folded plate 240. The first folded plate 230 and the second folded plate 240 are respectively connected between the first flat plate 210 and the second flat plate 220 to form a hollow pillar. The first folded plate 230 has a first part 232 and a second part 234, and the second folded plate 240 has a first part 242 and a second part 244. The first part 232 of the first folded plate 230 is connected to one edge of the first flat plate 210, and the second part 234 of the first folded plate 230 is connected to one edge of the second flat plate 220. The first part 242 of the second folded plate 240 is connected to another edge of the second flat plate 220, and the second part 244 of the second folded plate 240 is connected to another edge of the first flat plate 210. In addition, the directions of extension of the first parts 232, 242 of the first folded plate 230 and the second folded plate 240 are identical, and the directions of extension of the second parts 234, 244 of the first folded plate 230 and the second folded plate 240 are identical.

In the foregoing light integration rod 200, bends in the first folded plate 230 and the second folded plate 240 protrude away from a region between the first flat plate 210 and the second flat plate 220. Both the widths of the first flat plate 210 and the second flat plate 220 are D1, and a shortest distance between the first flat plate 210 and the second flat plate 220 is D2. A ratio D1/D2 is, for example, substantially equal to an aspect ratio of an imaging system, such as a digital micro-mirror device (DMD), of the optical projection apparatus. In other words, the aspect ratio of a rectangular area A shown in FIG. 3B is substantially identical to that of the imaging system. Furthermore, a distance D5 between an inner side of the bend of the first folded plate 230 and an imaginary line joining ends of the first flat plate 210 and the second flat plate 220 closest to the first folded plate 230 a the distance D6 between the inner side of the bend of the second folded plate 240 and the imaginary line joining the ends of the first flat plate 210 and the second flat plate 220 closest to the second folded plate 240 are, for example, between 0.1 mm˜0.4 mm. However, the present invention is not limited to such values.

In the following, the uniformity of output light beam from the light integration rod 200 in the present embodiment and the conventional light integration rod 100 (as shown in FIG. 100) are compared. The widths D5 and D6 of the light integration rod 200 are equal to 0.4 mm. In the table below, the measured luminosity of points 1˜13 as indicated in FIG. 4 are listed. However, the measured data in the following table should by no means limit the present invention.

TABLE 1

| | Light Integration | Light Integration |
|---|---|---|
| | Rod 100 | Rod 200 |
| Point 1 | 0.139383 | 0.14224 |
| Point 2 | 0.143701 | 0.13276 |
| Point 3 | 0.143269 | 0.120367 |
| Point 4 | 0.140999 | 0.13707 |
| Point 5 | 0.140135 | 0.138562 |
| Point 6 | 0.129767 | 0.135246 |
| Point 7 | 0.146495 | 0.138033 |
| Point 8 | 0.132876 | 0.142683 |
| Point 9 | 0.15423 | 0.133866 |
| Point 10 | 0.145029 | 0.138442 |
| Point 11 | 0.134968 | 0.131843 |
| Point 12 | 0.137535 | 0.150029 |
| Point 13 | 0.151809 | 0.140253 |
| ANSI Standard | 95.58% | 97.20% |

In Table 1, ANSI Standard represents the uniformity standard proposed by the American National Standards Institute (ANSI), which is, [X/Y-Z]/Z where X and Y are the maximum and minimum values of the measured luminosity among the points 1 to 13 and Z is the average of the measured luminosity among the points 1 to 9. As shown in Table 1, the light integration rod 200 in the present embodiment increases the uniformity level of the light beam as compared with the conventional one.

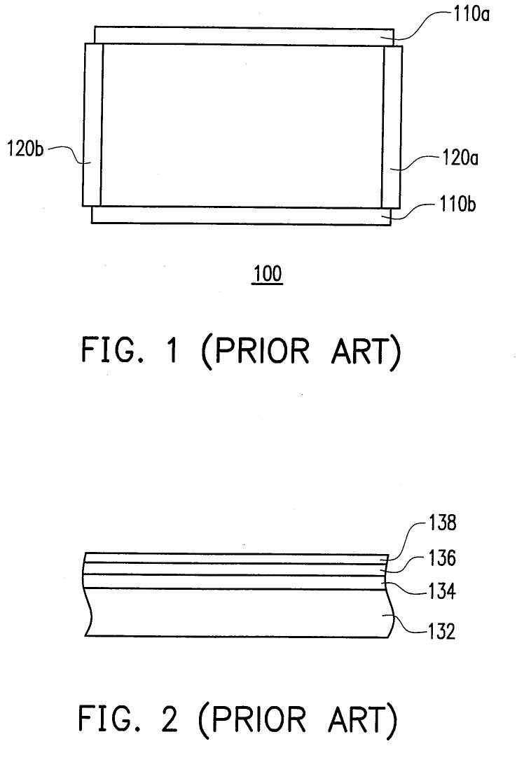

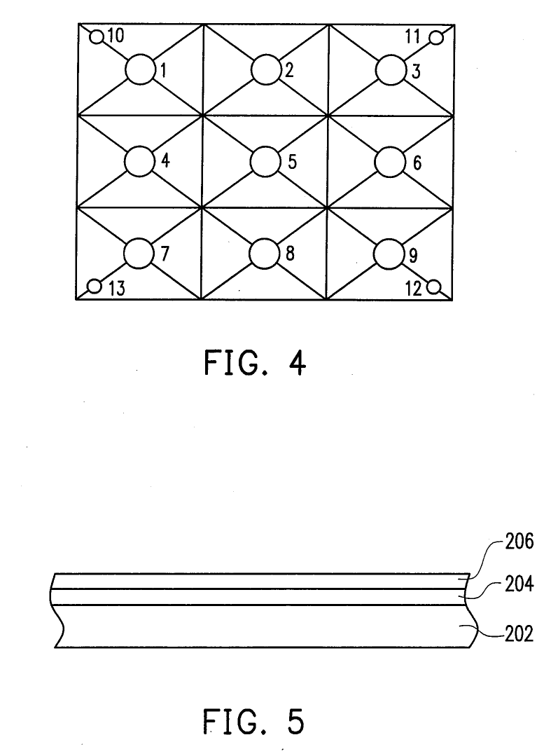

As shown in FIGS. 3A and 5, to resolve the problem of the reflective layer 136 being easily peeled off along with the adhered reinforcement layer 134 in the conventional light integration rod 100 (as shown in FIGS. 1 and 2), substrates of the first flat plate 210, the second flat plate 220, the first folded plate 230, and the second folded plate 240 in the present embodiment may be made of a metallic material. More specifically, each of the first flat plate 210, the second flat plate 220, the first folded plate 230, and the second folded plate 240 comprises a metallic substrate 202, a reflective layer 204 disposed on the metallic substrate 202 and a transparent protective layer 206 disposed on the reflective layer 204. A material of the metallic substrate 202 includes nickel or silicon, and a material of the reflective layer 204 includes a metal, such as, for example, aluminum, gold, or silver. A material of the transparent protective layer 206 includes argon.

Because the bonding strength between the reflective layer 204 and the metallic substrate 202 is stronger, the reflective layer 204 is not easily peeled off from the metallic substrate 202 as compared with the conventional art described in FIGS. 1 and 2. In addition, the metallic substrate 202 is capable of withstanding a higher stress and does not readily crack when the metallic substrate 202 is subject to pressure in a high temperature environment. Therefore, the light integration rod 200 in the present embodiment has a better reliability as compared with the conventional art described in FIGS. 1 and 2.

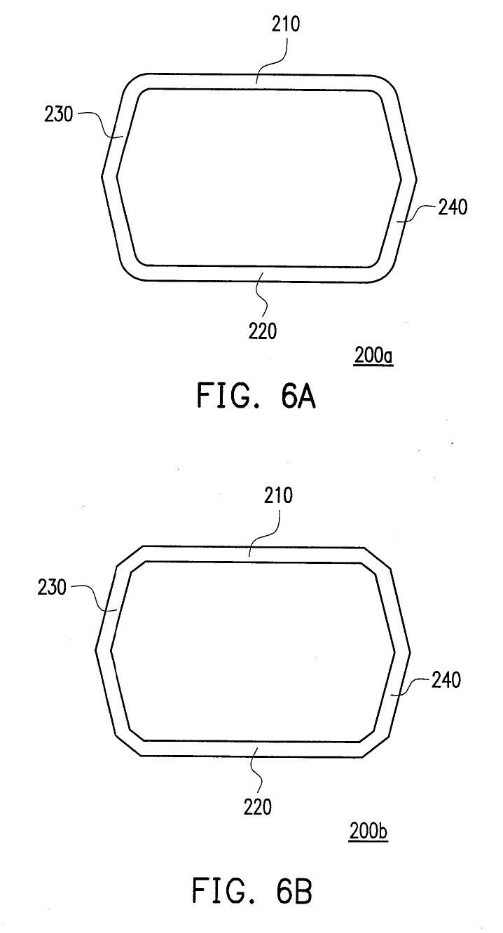

FIGS. 6A and 6B are schematic cross-sectional views showing another two types of the light integration rods according to the first embodiment of the present invention. As shown in FIGS. 6A and 6B, in general, stress is normally concentrated at the junctions between the first folded plate 230 and the first flat plate 210 and the second flat plate 220 and at the junctions between the second folded plate 240 and the first flat plate 210 and the second flat plate 220. In order to avoid stress at these junctions that may cause structural damage to the light integration rod, the junction between the first folded plate 230 and the first flat plate 210, the junction between the first folded plate 230 and the second flat plate 220, the junction between the second folded plate 240 and the first flat plate 210, and the junction between the second folded plate 240 and the second flat plate 220 are designed to have rounded corners (for example, the light integration rod 200a in FIG. 6A) or truncated corners (for example, the light integration rod 200b in FIG. 6B).

In the following, another three types of the light integration rods are introduced. Their shapes and advantages are similar to the light integration rod 200 shown in FIG. 3B.

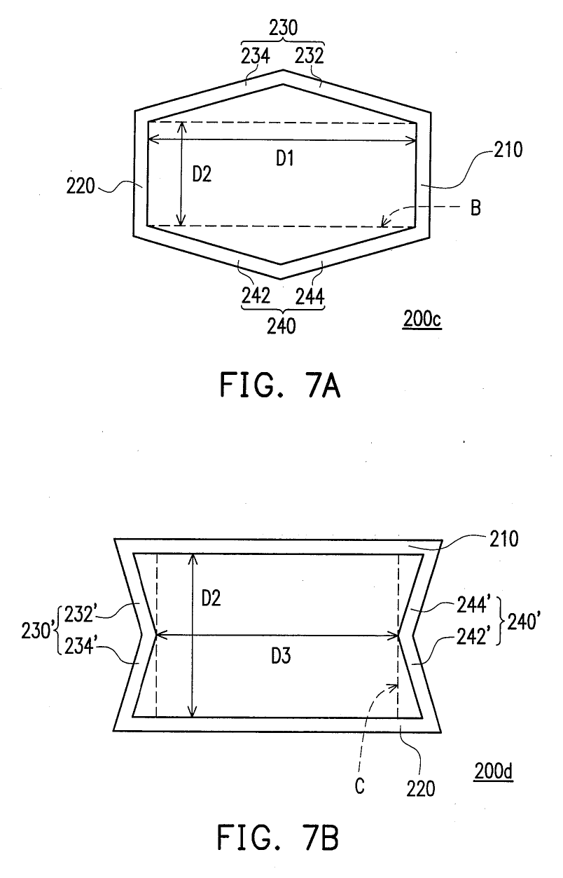

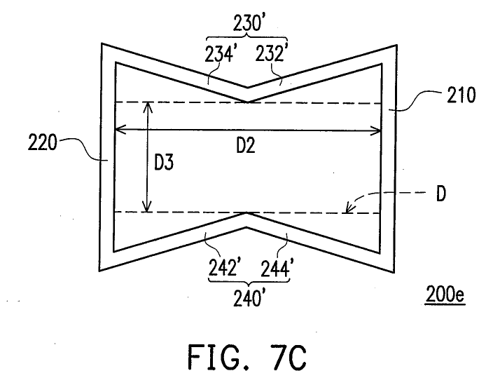

FIGS. 7A to 7C are schematic cross-sectional views showing another three types of the light integration rods according to the first embodiment of the present invention. As shown in FIG. 7A, the light integration rod 200c and the light integration rod 200 (as shown in FIG. 3B) are similar. The bends of the first folded plate 230 and the second folded plate 240 protrude away from the region between the first flat plate 210 and the second flat plate 220. The main difference between the light integration rod 200c and the light integration rod 200 is that the ratio D1/D2 of the light integration rod 200c is equal to the aspect ratio of the imaging system of the optical projection apparatus. In other words, the aspect ratio of a rectangular area B shown in FIG. 7A is substantially identical to that of the imaging system.

Next, as shown in FIGS. 7B and 7C, the bends of the first folded plate 230′ and the second folded plate 240′ of the light integration rods 200d, 200e cave into the region between the first flat plate 210 and the second flat plate 220. Furthermore, the shortest distance between the first flat plate 210 and the second flat plate 220 is D2 and the distance between the top of the bend of the first folded plate 230′ and the top of the bend of the second folded plate 240′ is D3. The ratio D3/D2 of the light integration rod 200d and the ratio D2/D3 of the light integration rod 200e are equal to the aspect ratio of the imaging system of the optical projection apparatus. In other words, the aspect ratios of rectangular areas C and D are substantially identical to that of the imaging system.

### Second Embodiment

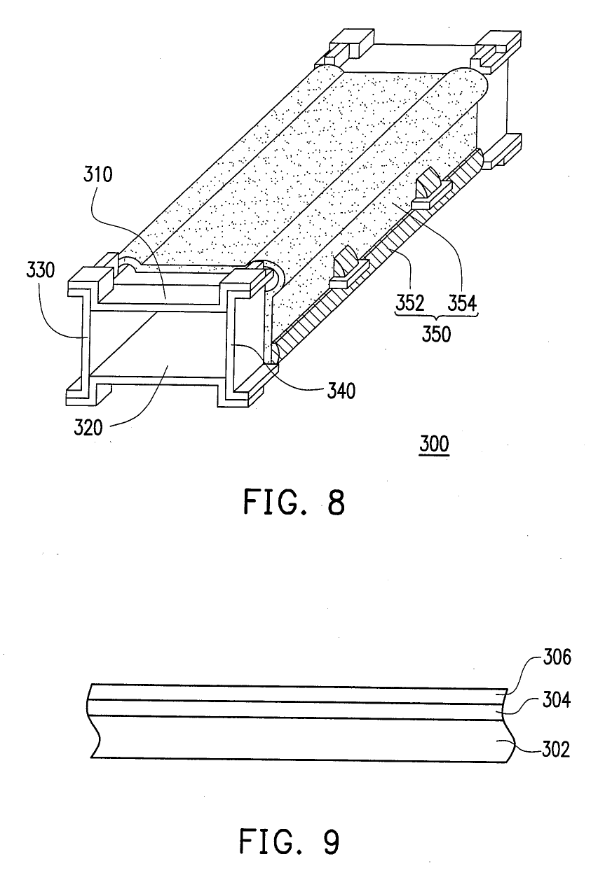

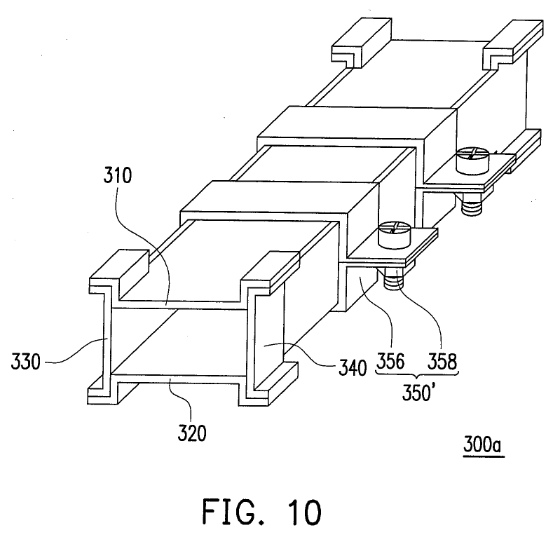

FIG. 8 is a perspective view of a light integration rod according to a second embodiment of the present invention. FIG. 9 is a schematic cross-sectional view showing a first flat plate, a second flat plate, a third flat plate and a fourth flat plate of the light integration rod according to the second embodiment of the present invention. As shown in FIGS. 8 and 9, a light integration rod 300 in the present embodiment includes a first flat plate 310, a second flat plate 320, a third flat plate 330 and a fourth flat plate 340. The second flat plate 320 is opposite to the first flat plate 310, and a shape of the first flat plate 310 is identical to a shape of the second flat plate 320. A shape of the third flat plate 330 is identical to a shape of the fourth flat plate 340. The third flat plate 310 and the fourth flat plate 330 are connected between the first flat plate 310 and the second flat plate 320 to form a hollow pillar. Each of the first flat plate 310, the second flat plate 320, the third flat plate 330 and the fourth flat plate 340 comprises a metallic substrate 302, a reflective layer 304 disposed on the metallic substrate 302 and a transparent protective layer 306 disposed on the reflective layer 304.

The metallic substrate 302 is made of a material such as nickel or silicon and the reflective layer 304 is made of a metallic material including, for example, aluminum, gold or silver. A material of the transparent protective layer 306 includes argon. Because the bonding strength between the reflective layer 304 and the metallic substrate 302 is stronger, the reflective layer 304 is not easily peeled off from the metallic substrate 302 as compared with the conventional art described in FIGS. 1 and 2. The metallic substrate 302 is capable of withstanding a higher stress and does not readily crack when the metallic substrate 302 is subject to pressure in a high temperature environment. Therefore, the light integration rod 300 in the present embodiment has a better reliability compared with the conventional art described in FIGS. 1 and 2.

It should be noted that a junction between the third flat plate 330 and the first flat plate 310, a junction between the third flat plate 330 and the second flat plate 320, a junction between the fourth flat plate 340 and the first flat plate 310, and a junction between the fourth flat plate 340 and the second flat plate 320 are designed to have rounded corners or truncated corners to avoid stress concentration at these junctions causing structural damage to the light integration rod 300.

Due to the concern on the problem of uniformity of the light beam emerging from the conventional light integration rod 100, which results from glue degradation and deformation, the first flat plate 310, the second flat plate 320, the third flat plate 330 and the fourth flat plate 340 of the present embodiment are fixed together by using a fixing component 350. More specifically, the fixing component 350 includes, for example, a first spring plate 352 and a second spring plate 354. The first spring plate 352 wraps around the second flat plate 320, and the second spring plate 354 wraps around the first, the third and the fourth flat plates 310, 330 and 340. The first spring plate 352 and the second spring plate 354 can be attached to each other by, for example, one or more latches.

By using the fixing component 350, the first flat plate 310, the second flat plate 320, the third flat plate 330 and the fourth flat plate 340 are fixed together to avoid the defect in the conventional light integration rod 100 due to glue degradation and rod deformation. As a result, the light integration rod 300 has a better reliability, compared with the conventional art described in FIGS. 1 and 2.

FIG. 10 is a perspective view of another type of the light integration rod according to the second embodiment of the present invention. As shown in FIG. 10, the main difference between the light integration rod 300a in the present embodiment and the light integration rod 300 in FIG. 8 is that a fixing component 350′ of the light integration rod 300a includes a plurality of metallic sleeves 356. Preferably, each metallic sleeve 356 surrounds the first flat plate 310, the second flat plate 320, the third flat plate 330 and the fourth flat plate 340 and is tightened up using a set of screws and nuts 358.

It should be noted that the method of using the fixing component 350 or 350′ to fix the first flat plate 310, the second flat plate 320, the third flat plate 330 and the fourth flat plate 340 can also be applied to various light integration rods in the first embodiment. It should also be noted that the term “plate” or “plates” used in the embodiments above or in the present invention is not limited by the case that the “plate” or “plates” requires a uniform thickness. Furthermore, the term “flat plate” or “flat plates” used in the embodiments above or in the present invention is not limited by the case that the “flat plate” or “flat plates” requires a rectangular cross section.

In summary, the light integration rod in the present invention has one or more or all of the following advantages:

1. An optical path of the light integration rod in the present invention has a cross-section approximate to a hexagonal shape so that the light beam emerging from the rod is more uniform compared with the conventional art described in FIGS. 1 and 2.

2. The metallic material is used to form the flat plates and the folded plates of the light integration rod so that the problem of the film being easily peeled off from the glass substrate in the conventional technique can be resolved and the light integration rod has a higher reliability.

3. Using a fixing component to fix the flat plates and the folded plates of the light integration rod prevents the problem caused by glue degradation and subsequent rod deformation in the conventional technique.

4. The junctions between various folded plates and flat plates can be designed to have the rounded corners or the truncated corners. This rounding or truncation of the sharp junctions avoids stress concentration and prevents possible damage to the light integration rod.

The foregoing description of the embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particular exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light integration rod for homogenizing a light beam from a light source in an optical projection apparatus, comprising:
a first flat plate;
a second flat plate opposite to the first flat plate, wherein a shape of the first flat plate is identical to a shape of the second flat plate;
a first folded plate; and
a second folded plate opposite to the first folded plate,
wherein the first folded plate and the second folded plate are respectively connected between the first flat plate and the second flat plate to form a hollow pillar, a shape of the first folded panel is identical to a shape of the second folded panel, each of the first folded plate and the second folded plate has a first part and a second part, the first part of the first folded plate is connected to a first edge of the first flat plate, the second part of the first folded plate is connected to a first edge of the second flat plate, the first part of the second folded plate is connected to a second edge of the second flat plate, the second part of the second folded plate is connected to a second edge of the first flat plate, and directions of extension of the first parts are identical and directions of extension of the second parts are identical.

2. The light integration rod of claim 1, wherein a bend of the first folded plate and a bend of the second folded plate respectively protrude away from a region between the first flat plate and the second flat plate.

3. The light integration rod of claim 2, wherein a width of the first flat plate and a width of the second flat plate are D1, a shortest distance between the first flat plate and the second flat plate is D2, and a ratio D1/D2 is equal to an aspect ratio of an imaging system in the optical projection apparatus.

4. The light integration rod of claim 2, wherein a width of the first flat plate and a width of the second flat plate are D1, a shortest distance between the first flat plate and the second flat plate is D2, and a ratio D2/D1 is equal to an aspect ratio of an imaging system in the optical projection apparatus.

5. The light integration rod of claim 2, wherein a distance between the bend of the first folded plate and an imaginary line joining an end of the first flat plate and an end of the second flat plate closest to the first folded plate is between 0.1 mm and 0.4 mm, and a distance between the bend of the second folded plate and an imaginary line joining an end of the first flat plate and an end of the second flat plate closest to the second folded plate is between 0.1 mm and 0.4 mm.

6. The light integration rod of claim 1, wherein a bend of the first folded plate and a bend of the second folded plate respectively cave into a region between the first flat plate and the second flat plate.

7. The light integration rod of claim 6, wherein a shortest distance between the first flat plate and the second flat plate is D2, a distance between a top of the bend of the first folded plate and a top of the bend of the second folded plate is D3, and a ratio D3/D2 is equal to an aspect ratio of an imaging system in the optical projection apparatus.

8. The light integration rod of claim 6, wherein a shortest distance between the first flat plate and the second flat plate is. D2, a distance between a top of the bend of the first folded plate and a top of the bend of the second folded plate is D3, and a ratio D2/D3 is equal to an aspect ratio of an imaging system in the optical projection apparatus.

9. The light integration rod of claim 1, wherein a junction between the first folded plate and the first flat plate, a junction between the first folded plate and the second flat plate, a junction between the second folded plate and the first flat plate, and a junction between the second folded plate and the second flat plate have rounded corners.

10. The light integration rod of claim 1, wherein a junction between the first folded plate and the first flat plate, a junction between the first folded plate and the second flat plate, a junction between the second folded plate and the first flat plate, and a junction between the second folded plate and the second flat plate have truncated corners.

11. The light integration rod of claim 1, wherein each of the first flat plate, the second flat plate, the first folded plate and the second folded plate comprises:
a metallic substrate;
a reflective layer, disposed on the metallic substrate; and
a transparent protective layer, disposed on the reflective layer.

12. The light integration rod of claim 11, wherein a material constituting the metallic substrate is selected from a group of nickel and silicon.

13. The light integration rod of claim 11, wherein a material constituting the reflective layer is selected from a group of aluminum, gold and silver, and a material of the transparent protective layer includes argon.

14. The light integration rod of claim 1, further comprising a fixing component that wraps around the first flat plate, the second flat plate, the first folded plate and the second folded plate to fix the first flat plate, the second flat plate, the first folded plate and the second folded plate.

15. A light integration rod for homogenizing a light beam from a light source in an optical projection apparatus, comprising:
a first flat plate;
a second flat plate opposite to the first flat plate, wherein a shape of the first flat plate is identical to a shape of the second flat plate;
a third flat plate; and
a fourth flat plate opposite to the third flat plate, wherein a shape of the third flat plate is identical to a shape of the fourth plate, the third flat plate and the fourth flat plate are respectively connected between the first flat plate and the second flat plate to form a hollow pillar, and each of the first flat plate, the second flat plate, the third flat plate and the fourth flat plate comprises:
a metallic substrate;
a reflective layer, disposed on the metallic substrate; and
a transparent protection layer, disposed on the reflective layer.

16. The light integration rod of claim 15, wherein a junction between the third flat plate and the first flat plate, a junction between the third flat plate and the second flat plate, a junction between the fourth flat plate and the first flat plate, and a junction between the fourth flat plate and the second flat plate have rounded corners.

17. The light integration rod of claim 15, wherein a junction between the third flat plate and the first flat plate, a junction between the third flat plate and the second flat plate, a junction between the fourth flat plate and the first flat plate, and a junction between the fourth flat plate and the second flat plate have truncated corners.

18. The light integration rod of claim 15, wherein a material constituting the metallic substrate is selected from a group of nickel and silicon.

19. The light integration rod of claim 15, wherein a material constituting the reflective layer is selected from a group of aluminum, gold, and silver.

20. The light integration rod of claim 15, further comprising a fixing component that wraps around the first flat plate, the second flat plate, the third flat plate and the fourth flat plate to fix the first flat plate, the second flat plate, the third flat plate and the fourth flat plate.
